(19) United States
(12) Patent Application Publication
(10) Pub. No.: US 2025/0222822 A1
(43) Pub. Date: Jul. 10, 2025

(54) VEHICLE DISPLAY DEVICE AND VEHICLE CONTROL DEVICE

(71) Applicant: TOYOTA JIDOSHA KABUSHIKI KAISHA, Toyota-shi (JP)

(72) Inventor: Hiroto AMADA, Nisshin-shi (JP)

(73) Assignee: TOYOTA JIDOSHA KABUSHIKI KAISHA, Toyota-shi (JP)

(21) Appl. No.: 18/955,182

(22) Filed: Nov. 21, 2024

(30) Foreign Application Priority Data
Jan. 10, 2024 (JP) 2024-002048

(51) Int. Cl. B60L 58/12; B60L 58/27

(52) U.S. Cl. CPC B60L 58/12; B60L 58/27

(57) ABSTRACT

A vehicle display device includes a traveling motor, a battery that exchanges electric power with the motor, and a heater that operates with electric power from the battery and heats the battery, is used in a battery electric vehicle where a temperature rise control for operating a heater is performed so that a temperature of a battery rises to a target temperature at a low temperature, and displays information. The vehicle display device displays a first distance calculated as a travelable distance of a battery electric vehicle when the temperature rise control is executed, and the temperature rise control is not executed based on a current state of the battery, and a second distance calculated as a travelable distance of a battery electric vehicle when the temperature rise control is completed based on a predicted state predicted as a state of the battery when the temperature rise control is completed.

### CROSS-REFERENCE TO RELATED APPLICATION

This application claims priority to Japanese Patent Application No. 2024-002048 filed on Jan. 10, 2024, incorporated herein by reference in its entirety.

### BACKGROUND

### 1. Technical Field

The present disclosure relates to a vehicle display device and a vehicle control device.

### 2. Description of Related Art

Hitherto, there has been proposed a battery electric vehicle including an electric motor, a battery that exchanges electric power with the electric motor, a heater (battery temperature adjusting device) that operates with electric power from the battery and raises the temperature of the battery by supplying hot air or hot water, and an air conditioner that performs air conditioning in a vehicle cabin (see, for example, Japanese Unexamined Patent Application Publication No. 2019-193319 (JP 2019-193319 A)). In this automobile, the heater is operated to raise the temperature of the battery, and the air conditioner is controlled so that the vehicle cabin has an appropriate temperature in advance in accordance with a scheduled departure time. Since both the operation of the heater and the operation of the air conditioner consume the electric power of the battery, the load on the battery may increase and the travelable distance (cruising distance) may decrease. Therefore, the period for operating both the heater and the air conditioner is shortened by adjusting the respective start times, thereby reducing the load on the battery.

### SUMMARY

In the above battery electric vehicle, however, the user cannot recognize the effect of increasing the travelable distance by the operation of the heater. When the heater operates at a low temperature, the temperature of the battery rises and the amount of electric power that can be discharged from the battery increases, thereby increasing the travelable distance. Since the heater operates with the electric power from the battery, the power storage ratio of the battery decreases. When the user cannot recognize the effect of the temperature rise of the battery, the user may feel that the temperature rise of the battery is unnecessary, and therefore, it is recognized as an important issue to allow the user to recognize the effect of the temperature rise of the battery.

A vehicle display device and a vehicle control device according to the present disclosure are mainly intended to allow a user to recognize an effect of temperature rise of a battery.

The vehicle display device and the vehicle control device of the present disclosure adopt the following means in order to achieve the above main object.

A vehicle display device of the present disclosure is a vehicle display device configured to display information and to be used in a battery electric vehicle that includes a motor for traveling, a battery configured to exchange electric power with the motor, and a heater configured to heat the battery by operating with the electric power from the battery, and that is configured to perform temperature rise control for operating the heater to cause a temperature of the battery to rise to a target temperature when a temperature is low.

The vehicle display device is configured to display a first distance and a second distance when the temperature rise control is being performed. The first distance is calculated as a travelable distance of the battery electric vehicle when the temperature rise control is not performed based on a current state of the battery, and the second distance is calculated as a travelable distance of the battery electric vehicle when the temperature rise control is completed based on a predicted state that is predicted as a state of the battery when the temperature rise control is completed.

The vehicle display device of the present disclosure is configured to, when the temperature rise control is being performed, display the first distance calculated as the travelable distance of the battery electric vehicle when the temperature rise control is not performed based on the current state of the battery, and the second distance calculated as the travelable distance of the battery electric vehicle when the temperature rise control is completed based on the predicted state that is predicted as the state of the battery when the temperature rise control is completed. Since the first distance and the second distance are displayed, the user can recognize the effect of the temperature rise of the battery.

In the vehicle display device of the present disclosure, the first distance may be a distance obtained by calculating an amount of electric power dischargeable from the battery and multiplying the calculated amount of electric power by an electric efficiency of the battery electric vehicle. The amount of electric power may be calculated based on a current power storage ratio and a current temperature of the battery. In this way, the first distance can be calculated based on the current power storage ratio and the current temperature of the battery.

In the vehicle display device of the present disclosure, the second distance may be a distance obtained by calculating a power consumption from start to completion of the temperature rise control, calculating a completion time ratio, calculating an amount of electric power dischargeable from the battery, and multiplying the calculated amount of electric power by an electric efficiency of the battery electric vehicle. The power consumption may be calculated by multiplying a temperature difference obtained by subtracting a current temperature of the battery from the target temperature by a heat capacity of the battery. The completion time ratio may be calculated by subtracting, from a current power storage ratio of the battery, a consumption ratio obtained by converting the power consumption into the power storage ratio of the battery. The amount of electric power may be calculated based on the completion time ratio and the target temperature. In this way, the second distance can be calculated from the target temperature, the current temperature of the battery, the heat capacity of the battery, and the current power storage ratio of the battery.

A vehicle control device of the present disclosure is a vehicle control device to be used in a battery electric vehicle that includes a motor for traveling, a battery configured to exchange electric power with the motor, a heater configured to heat the battery by operating with the electric power from the battery, and a display device configured to display information.

The vehicle control device is configured to perform temperature rise control for operating the heater to cause a temperature of the battery to rise to a target temperature when a temperature is low, and to control the display device.

The vehicle control device includes:
a selection receiving unit configured to receive selection as to whether to perform the temperature rise control; and
a control performing unit configured to display a first distance and a second distance on the display device, and perform the temperature rise control when selection to perform the temperature rise control is received by the selection receiving unit. The first distance is calculated as a travelable distance of the battery electric vehicle when the temperature rise control is not performed based on a current state of the battery, and the second distance is calculated as a travelable distance of the battery electric vehicle when the temperature rise control is completed based on a predicted state that is predicted as a state of the battery when the temperature rise control is completed.

In the vehicle control device of the present disclosure, the selection as to whether to perform the temperature control is received. The vehicle control device displays the first distance and the second distance on the display device, and performs the temperature rise control when the selection to perform the temperature rise control is received by the selection receiving unit. The first distance is calculated as the travelable distance of the battery electric vehicle when the temperature rise control is not performed based on the current state of the battery. The second distance is calculated as the travelable distance of the battery electric vehicle when the temperature rise control is completed based on the predicted state that is predicted as the state of the battery when the temperature rise control is completed. Since the first distance and the second distance are displayed before the temperature rise control is performed, the user can recognize the effect of the temperature rise of the battery.

In the vehicle control device of the present disclosure, the first distance and the second distance may be displayed on the display device while the temperature rise control is being performed. This allows the user to recognize the effect of the temperature rise of the battery even while the temperature rise control is being performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle 20 in which a vehicle display device according to an embodiment of the present disclosure is mounted;

FIG. 2 is a flow chart showing an exemplary process routine executed by the electronic control unit 50 of battery electric vehicle 20 on which the vehicle display device of the present embodiment is mounted;

FIG. 3 is an explanatory diagram illustrating an example of a relationship between a battery temperature and an electricity storage ratio;

FIG. 4 is an explanatory diagram illustrating an exemplary display of the display 42; and

FIG. 5 is an explanatory diagram illustrating an example of the display of the display 42 during execution of the temperature rise control.

### DETAILED DESCRIPTION OF EMBODIMENTS

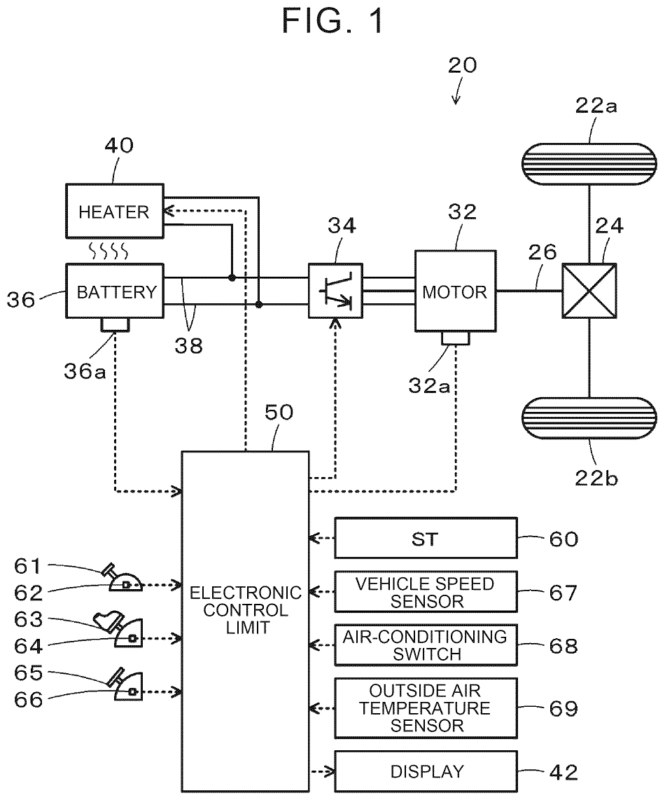

Embodiments of the present disclosure will be described with reference to the drawings. FIG. 1 is a schematic configuration diagram of a battery electric vehicle 20 in which a vehicle display device according to an embodiment of the present disclosure is mounted. As illustrated, battery electric vehicle 20 of the embodiment includes a driving motor 32, an inverter 34, a battery 36 as a power storage device, heaters 40, a display 42, and an electronic control unit (hereinafter referred to as “ECU”) 50.

The motor 32 is configured as a three-phase AC motor, and includes a rotor in which a permanent magnet is embedded in a rotor core, and a stator in which a three-phase coil is wound around the stator core. The rotor of the motor 32 is connected to a drive shaft 26 connected to the drive wheel 22a, 22b via a differential gear 24.

Inverter 34 is used to drive motor 32 and is connected to power line 38. When a DC voltage is applied to the inverter 34, a plurality of switching elements of the inverter 34 are switched and controlled by the electronic control unit 50, whereby a rotating magnetic field is formed in the three-phase coil of the motor 32, and the motor 32 is rotationally driven.

The battery 36 is configured as, for example, a lithium-ion secondary battery or a nickel-hydrogen secondary battery having a rated voltage of about several hundred V, and is connected to the power line 38.

The heater 40 is connected to the power line 38 and heats the battery 36. The heater 40 is controlled by an electronic control unit 50.

The display 42 is configured as a touch panel display capable of performing various operations by touching a screen. The display 42 displays various types of information. The display 42 is controlled by an electronic control unit 50.

The electronic control unit 50 includes a microcomputer, and the microcomputer includes a CPU, a ROM, RAM, a flash memory, an input/output port, and a communication port. Signals from various sensors are input into the electronic control unit 50 through the input port. Examples of the signal inputted to the electronic control unit 50 include a rotational position Om from a 32a of a rotational position sensor (for example, a resolver) that detects the rotational position of the rotor of the motor 32, and a phase current Iv, Iw from a current sensor that detects the V-phase and W-phase currents of the motor 32. A voltage Vb from a voltage sensor mounted between terminals of the battery 36 and a current Ib from a current sensor mounted at an output terminal of the battery 36 may also be mentioned. A start signal from the start switch 60 and a shift position SP from the shift sensor 62 that detects the operating position of the shift lever 61 can also be cited. An accelerator operation amount Acc from the accelerator sensor 64 that detects the depression amount of the accelerator pedal 63 and a brake pedal position from the brake sensor 66 that detects the depression amount of the brake pedal 65 can also be cited. The vehicle speed V from the vehicle speed sensor 67 can also be cited. A battery temperature Tb from the temperature sensor 36a for detecting the temperature of the battery 36 and an outside air temperature Tatm from the outside air temperature sensor 69 for detecting the outside air temperature can also be cited.

Various control signals are output from the electronic control unit 50 through the output port. Examples of the signal output from the electronic control unit 50 include a control signal to the inverter 34, a control signal to the heater 40, and an image signal to the display 42 configured as a touch display for displaying various kinds of information. The electronic control unit 50 calculates the power storage ratio SOC of the battery 36 based on the current Ib of the battery 36 from the current sensor. The power storage ratio SOC represents a rate of capacity of electric power that can be discharged from the battery 36, with respect to the full capacity of the battery 36.

In battery electric vehicle 20 of the embodiment, the electronic control unit 50 sets the required torque Td*, and sets the torque command Tm* of the motor 32 so that the required torque Td* is outputted to the drive shaft 26. The required torque Td* is required for traveling based on the accelerator operation amount Acc and the vehicle speed V (required for the drive shaft 26). Then, the electronic control unit 50 performs switching control of the plurality of switching elements of the inverter 34 so that the motor 32 is driven by the torque command Tm*.

In battery electric vehicle 20 of the embodiment, the electronic control unit 50 performs temperature raising control to raise the temperature of the battery 36 by operating the heaters 40 so that the battery temperature Tb becomes the target temperature Tb* (e.g., 8° C., 10° C., 12° C., etc.) at a low temperature.

Further, in battery electric vehicle 20 of the embodiment, the electronic control unit 50 calculates the power cost Ec that is the travel distance per unit electric power amount every predetermined period (for example, several msec).

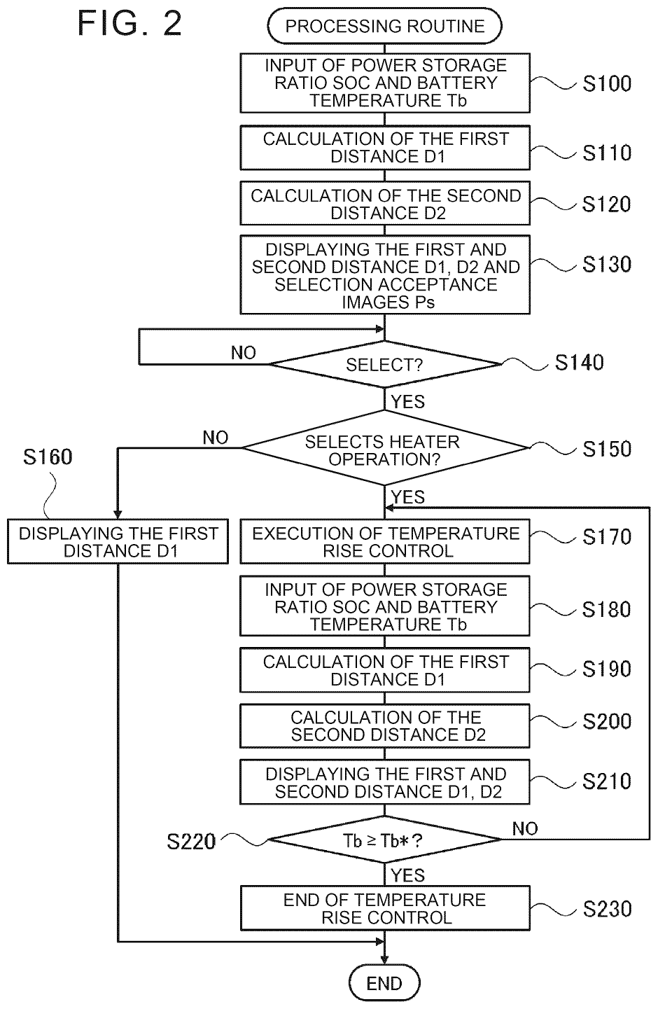

Next, an operation of battery electric vehicle 20 equipped with the vehicle display device of the present embodiment configured as described above, in particular, an operation at a low temperature will be described. FIG. 2 is a flow chart showing an exemplary process executed by the electronic control unit 50 in battery electric vehicle 20 where the vehicle display device according to the present embodiment is mounted. This routine is executed when the start switch 60 is turned on and battery electric vehicle 20 is started when the outside air temperature Tatm from the outside air temperature sensor 69 is at a battery electric vehicle 20 stop at a low temperature equal to or lower than the determination temperature Tref (for example, −5° C., 0° C., 5° C., or the like). When the activation of battery electric vehicle 20 is completed while the process routine illustrated in FIG. 2 is being executed, battery electric vehicle 20 may be started to travel.

When the present routine is executed, CPU of the electronic control unit 50 executes a process of inputting the power storage ratio SOC and the battery temperature Tb of the present battery 36 (S100). The power storage ratio SOC is calculated based on the current Ib of the battery 36 from the current sensor. The battery temperature Tb is inputted as detected by the temperature sensor 36a.

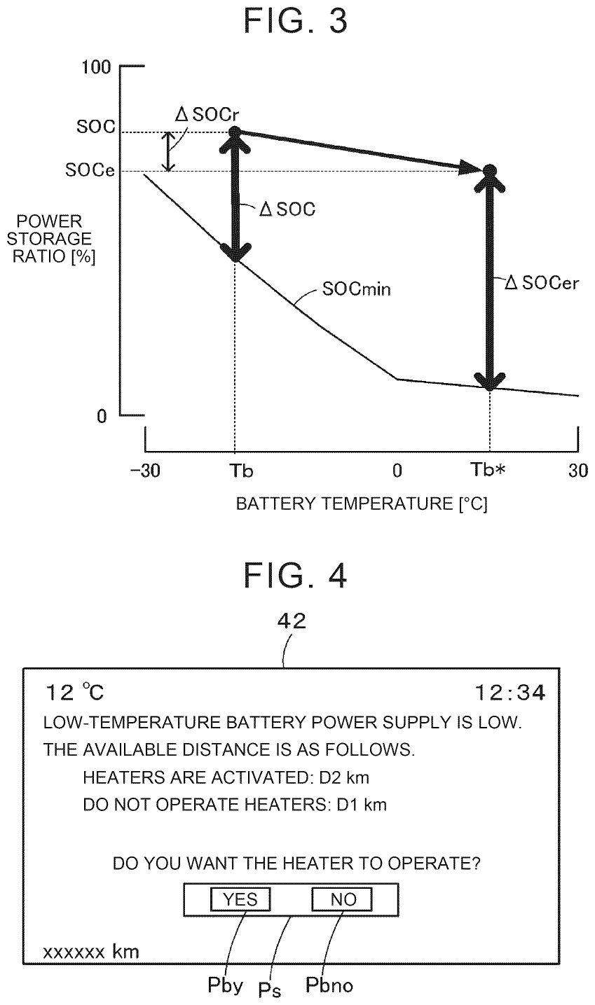

Subsequently, the first distance D1 is calculated (S110). The first distance D1 is calculated as the travelable distance of battery electric vehicle 20 when the temperature rise control is not executed. The first distance D1 is a distance obtained by calculating the dischargeable power amount Wdch from the battery 36 and multiplying the calculated power amount Wdch by the power cost Ec of the battery electric vehicle 20. The electric energy Wdch is calculated based on the present state of the battery 36, that is, the power storage ratio SOC and the battery temperature Tb inputted in S100. FIG. 3 is an explanatory diagram illustrating an example of a relationship between a battery temperature and an electricity storage ratio. In the drawing, a solid line represents a lower limit SOCmin of the power storage ratio SOC of the battery 36. The lower limit SOCmin is set to be higher when the battery temperature Tb is higher than when the battery temperature is lower. This is based on the fact that the inner resistance is increased and the discharging capacity is decreased when the battery temperature Tb is lower than when the battery temperature is higher. The electric energy Wdch is obtained by converting the ratio difference ΔSOC obtained by subtracting the lower limit SOCmin in the battery temperature Tb from the power storage ratio SOC inputted in S100 into the electric energy.

Next, the second distance D2 is calculated (S120). The second distance D2 is calculated as the travelable distance of battery electric vehicle 20 when the temperature increase control is completed. The calculation of the second distance D2 is performed as follows. First, the predicted state predicted as the state of the battery 36 when the temperature increase control is completed, that is, the power consumption amount ΔWr from the start to the completion of the temperature increase control is calculated. The power consumption amount ΔWr is calculated by multiplying the temperature difference obtained by subtracting the present temperature of the battery 36 (in the battery temperature Tb inputted in S120 by S100) from the target temperature Tb* in the temperature increase control by the heat capacity of the battery 36. Then, as shown in FIG. 3, the consumed rate ΔSOCr is subtracted from the present storage rate of the battery 36 (in S120, the power storage ratio SOC inputted in S100) to calculate the completion time ratio SOCe (=SOC-ΔSOCr). The consumption rate ΔSOCr is calculated by converting the power consumption rate ΔWr into the power storage rate of the battery 36. Further, the second distance D2 is calculated by converting the ratio difference ΔSOCer obtained by subtracting the lower limit value SOCmin when the temperature of the battery 36 is the target temperature Tb* from the completion time ratio SOCe into the electric energy and multiplying the electric energy by the power cost Ec.

When the first and second distance D1, D2 are calculated in this manner, the electronic control unit 50 displays the first and second distance D1, D2 and selection acceptance images Ps for selecting whether or not to operate the heaters 40 on S130 42. The electronic control unit 50 waits until the selection acceptance image Ps is selected (S140). FIG. 4 is an explanatory diagram illustrating an example of the display of the display 42. The electronic control unit 50 controls the display 42 so that the first and second distance D1, D2 and the selection acceptance images Ps are displayed. On the display 42, the outside air temperature Tatm (12° C. in FIG. 4) and the present time TIME (12:34 in FIG. 4) are displayed. The selection acceptance image Ps includes a selection button image Pby for selecting to activate the heater 40 and a selection button image Pbno for selecting not to activate the heater 40. As described above, since the display 42 displays the first and second distance D1, D2, the user can visually recognize the travelable distance before and after the temperature rise of the battery 36 by operating the heaters 40. This allows the user to recognize the effect of increasing the temperature of the battery 36. In addition, the user can confirm the first and second distance D1, D2 and select whether or not to activate the heaters 40, that is, whether or not to execute the temperature increase control, since the selection acceptance image Ps is displayed together with the first and second distance D1, D2.

When S140 selects the selection acceptance image Ps, the electronic control unit 50 determines whether or not the operation of the heaters 40, that is, the execution of the temperature increase control, has been selected (S150). When the operation of the heater 40 is not selected, the first distance D1 is displayed on S160 42, and the routine ends. In this case, the temperature rise control is not executed.

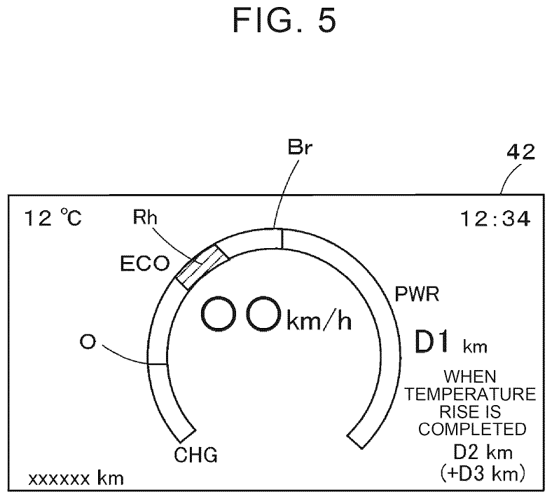

When the operation of the heaters 40 is selected in S150, the temperature rise control is executed (S170). Then, the power storage ratio SOC and the battery temperature Tb of the present battery 36 are inputted from S100 by the same process as that of S120 (S180), the first distance D1 is calculated (S190), and the second distance D2 is calculated (S200). In S190, S200, the first distance D1 and the second distance D2 are calculated using the power storage ratio SOC and the battery temperature Tb inputted in S180. Then, the first and second distance D1, D2 are displayed on the display 42 (S210). FIG. 5 is an explanatory diagram illustrating an example of the display of the display 42 during execution of the temperature rise control. The electronic control unit 50 controls the display 42 so that the outside air temperature Tatm (12° C. in FIG. 5), the present time TIME (12:34 in FIG. 5), and the first and second distance D1, D2 are displayed. The display 42 also displays the outside air temperature Tatm, the present time TIME, the power outputted from the motor 32, and the vehicle speed V. The power outputted from the motor 32 is displayed as a highlighted area Rh in the curved bar Br (with a lane in the drawing). As the power outputted from the motor 32 is increased, the highlighted area Rh changes from the origin position O through the “ECO” zone to indicate the “PWR” zone. The “ECO” zone indicates a range of power that can be traveled in which the power outputted from the motor 32 is suppressed and a decrease in the power storage ratio of the battery 36 is suppressed. When the power output from the motor 32 decreases, the highlighted area Rh changes toward the origin position O, and when the power output from the motor 32 further decreases, the highlighted area Rh changes from the origin position O to indicate the “CHG” zone. Since the display 42 displays the first and second distance D1, D2, the user can visually recognize the travelable distance before and after the temperature rise of the battery 36 by the operation of the heaters 40. This allows the user to recognize the effect of increasing the temperature of the battery 36.

When displayed in the first and second distance D1, D2 in this manner, next, it is determined whether or not the battery temperature Tb inputted in S180 is equal to or higher than the target temperature Tb* (S220). When the battery temperature Tb is less than the target temperature Tb*, it is determined that the temperature of the battery 36 is not sufficiently increased, and S170 to S220 is repeated until the battery temperature Tb becomes equal to or higher than the target temperature Tb*. Then, when the battery temperature Tb becomes equal to or higher than the target temperature Tb* in S220, it is determined that the temperature of the battery 36 has sufficiently increased, and the temperature raising control is ended (S230), and this routine is ended.

According to battery electric vehicle 20 of mounting the vehicle display device of the present embodiment described above, when the temperature rise control is executed, the first distance D1 and the second distance D2 are displayed, so that the user can recognize the effectiveness of the temperature rise of the battery 36. Here, the first distance D1 is calculated as the travelable distance of battery electric vehicle 20 when the temperature rise control is not executed based on the present condition of the battery 36. The second distance D2 is calculated as the travelable distance of battery electric vehicle 20 when the temperature rise control is completed based on the predicted state predicted as the state of the battery 36 when the temperature rise control is completed.

Further, the first distance D1 is a distance obtained by calculating the dischargeable power amount Wdch from the battery 36 and multiplying the calculated power amount Wdch by the power cost Ec of the battery electric vehicle 20. According to the above configuration, the first distance D1 can be calculated on the basis of the power storage ratio SOC of the battery 36 and the battery temperature Tb.

Further, the second distance D2 is calculated by calculating the power consumption amount ΔWr from the start to the completion of the temperature increase control, subtracting the consumption ratio ΔSOCr from the current power storage ratio of the battery 36 to calculate the completion time ratio SOCe, calculating the lower limit value SOCmin based on the completion time ratio SOCe and the target temperature Tb*, converting the ratio difference ΔSOCer obtained by subtracting the lower limit value SOCmin from the completion time ratio SOCe into the power amount, and multiplying the power cost Ec. The power consumption ΔWr is calculated by multiplying the temperature difference obtained by subtracting the present temperature of the battery 36 from the target temperature Tb* in the temperature increase control by the heat capacity of the battery 36. The consumption rate ΔSOCr is calculated by converting the power consumption rate ΔWr into the power storage rate of the battery 36.

In the above-described embodiment, S140 is executed from S100. That is, the first and second distance D1, D2 and the selection acceptance image Ps are displayed on the display 42, and the user is made to recognize the effectiveness of the temperature rise of the battery 36, and then the user is made to select whether or not to execute the temperature rise control. However, it may be determined whether or not the temperature rise control is being executed instead of S150 without executing S140 from S100. Here, the temperature increase control may be performed when the outside air temperature Tatm is lower than a predetermined temperature (for example, 0° C.).

In the above-described embodiment, a selection acceptance image Ps for selecting whether or not to operate the heater 40 is displayed on the display 42, and the temperature rise control is executed when the operation of the heater 40, that is, the execution of the temperature rise control is selected. However, instead of the selection acceptance image Ps, whether or not to operate the heaters 40, that is, whether or not to execute the temperature increase control may be outputted as a sound. Then, a selection of whether or not to execute the temperature rise control by speech recognition may be accepted. A button for selecting whether or not to execute the temperature increase control may be provided, and the selection of whether or not to execute the temperature increase control may be accepted by detecting the depression of the button.

The correspondence between the main elements of the embodiments and the main elements of the disclosure described in the column of the means for solving the problem will be described. In the embodiment, in the vehicle display device of the present disclosure, the motor 32 corresponds to a “motor”, the battery 36 corresponds to a “battery”, the heater 40 corresponds to a “heater”, and the display 42 corresponds to a “vehicle display device”. In the vehicle control device of the present disclosure, the motor 32 corresponds to a “motor”, the battery 36 corresponds to a “battery”, the heater 40 corresponds to a “heater”, the display 42 corresponds to a “display device”, and the electronic control unit 50 corresponds to a “vehicle control device”. Further, in the vehicle control device of the present disclosure, the display 42 corresponds to the “selection receiving unit”, and the electronic control unit 50 corresponds to the “control performing unit”.

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described above, the present disclosure is not limited to such embodiments at all, and it is needless to say that the present disclosure can be carried out in various forms without departing from the gist of the present disclosure.

The present disclosure is applicable to a vehicle display device, a manufacturing industry of a vehicle control device, and the like.

What is claimed is:

1. A vehicle display device configured to display information and to be used in a battery electric vehicle that includes a motor for traveling, a battery configured to exchange electric power with the motor, and a heater configured to heat the battery by operating with the electric power from the battery, and that is configured to perform temperature rise control for operating the heater to cause a temperature of the battery to rise to a target temperature when a temperature is low, wherein the vehicle display device is configured to display a first distance and a second distance when the temperature rise control is being performed, the first distance being calculated as a travelable distance of the battery electric vehicle when the temperature rise control is not performed based on a current state of the battery, and the second distance being calculated as a travelable distance of the battery electric vehicle when the temperature rise control is completed based on a predicted state that is predicted as a state of the battery when the temperature rise control is completed.

2. The vehicle display device according to claim 1, wherein the first distance is a distance obtained by calculating an amount of electric power dischargeable from the battery and multiplying the calculated amount of electric power by an electric efficiency of the battery electric vehicle, the amount of electric power being calculated based on a current power storage ratio and a current temperature of the battery.

3. The vehicle display device according to claim 1, wherein the second distance is a distance obtained by calculating a power consumption from start to completion of the temperature rise control, calculating a completion time ratio, calculating an amount of electric power dischargeable from the battery, and multiplying the calculated amount of electric power by an electric efficiency of the battery electric vehicle, the power consumption being calculated by multiplying a temperature difference obtained by subtracting a current temperature of the battery from the target temperature by a heat capacity of the battery, the completion time ratio being calculated by subtracting, from a current power storage ratio of the battery, a consumption ratio obtained by converting the power consumption into the power storage ratio of the battery, and the amount of electric power being calculated based on the completion time ratio and the target temperature.

4. A vehicle control device to be used in a battery electric vehicle that includes a motor for traveling, a battery configured to exchange electric power with the motor, a heater configured to heat the battery by operating with the electric power from the battery, and a display device configured to display information, the vehicle control device being configured to perform temperature rise control for operating the heater to cause a temperature of the battery to rise to a target temperature when a temperature is low, and to control the display device, the vehicle control device comprising:
a selection receiving unit configured to receive selection as to whether to perform the temperature rise control; and
a control performing unit configured to display a first distance and a second distance on the display device, and perform the temperature rise control when selection to perform the temperature rise control is received by the selection receiving unit, the first distance being calculated as a travelable distance of the battery electric vehicle when the temperature rise control is not performed based on a current state of the battery, and the second distance being calculated as a travelable distance of the battery electric vehicle when the temperature rise control is completed based on a predicted state that is predicted as a state of the battery when the temperature rise control is completed.

5. The vehicle control device according to claim 4, wherein the first distance and the second distance are displayed on the display device while the temperature rise control is being performed.
